(19) United States
(12) Patent Application Publication
(10) Pub. No.: US 2026/0210089 A1
(43) Pub. Date: Jul. 23, 2026

(54) WORKING MACHINE

(71) Applicant: Yanmar Holdings Co., Ltd., Osaka (JP)

(72) Inventors: Hiromu Nagata, Fukuoka (JP); Megumi Yamamoto, Fukuoka (JP)

(73) Assignee: Yanmar Holdings Co., Ltd., Osaka (JP)

(21) Appl. No.: 19/430,136

(22) Filed: Dec. 22, 2025

(30) Foreign Application Priority Data
Jan. 23, 2025 (JP) 2025-009915
Jan. 23, 2025 (JP) 2025-009920

(51) Int. Cl. E02F 9/26; E02F 3/32

(52) U.S. Cl. CPC E02F 9/264; E02F 3/325

(57) ABSTRACT

A working machine includes a posture detection device attached to a blade of a soil discharging device provided in front of a machine body, a reception device that receives position information of the blade from the outside, and a controller that communicates with the posture detection device and the reception device. The controller is arranged in front of a driver's seat in an operating part provided in the machine body.

### CROSS-REFERENCE

This application claims foreign priority of JP 2025-009915 filed Jan. 23, 2025, and JP 2025-009920 filed Jan. 23, 2025, the disclosures of which are hereby incorporated by reference in their entirety.

### TECHNICAL FIELD

The present invention relates to a working machine.

### BACKGROUND ART

Conventionally, for example, a construction machine according to Patent Document 1 is known as a working machine such as a hydraulic excavator. In the construction machine described above, a cable storage box is arranged above an exterior cover located on the right side of a driver's seat. The cable storage box houses a controller and a part of a cable connected to the controller. The controller controls a control valve for a blade based on position information and posture information of the blade of a soil discharging device. Thus, when ground leveling work is performed using the soil discharging device, an operation of the soil discharging device is controlled according to three-dimensional data of ground to be worked.

Furthermore, conventionally, a working machine of Patent Document 2, for example, is known. In the working machine, two types of monitors are installed in an operating space (hereinafter, referred to as an operating part) where a working device is operated.

### PRIOR ART DOCUMENTS

### Patent Documents

Patent Document 1: JP-A-2021-6696

Patent Document 2: JP-A-2017-8582

### SUMMARY OF INVENTION

### Technical Problem

In a configuration of Patent Document 1, the cable storage box that houses the controller is arranged on the side of the driver's seat. Therefore, there is a possibility a lateral view field of an operator seated on the driver's seat is obstructed by the cable storage box. That is, there is a possibility that the lateral view field of the operator is obstructed due to the arrangement of the controller.

The present invention has been made to solve the above problem, and an object of the present invention is to provide a working machine capable of reducing a possibility that lateral view field of an operator seated on a driver's seat is obstructed due to the arrangement of a controller.

Furthermore, in the working machine of Patent Document 2, operation levers for operating the working device are installed on both sides of a driver's seat installed in the operating part. Then, a monitor (for example, an auxiliary monitor installed additionally) is arranged in front of a grip part of the operation lever on the right side. In such arrangement of the monitor, when an operator seated on the driver's seat operates the monitor, there is a possibility that the operator's hand or arm erroneously comes into contact with the operation lever, resulting in an unintended operation of the working device. Furthermore, when a plurality of monitors are installed in the operating space, it is also important to ensure visibility of the plurality of monitors.

The present invention has been made to solve the above problem, and an object thereof is to provide a working machine capable of ensuring visibility of each of a plurality of monitors even when the plurality of monitors are installed in an operating part and reducing a possibility that an operator erroneously comes into contact with an operation lever when operating the plurality of monitors.

### Solution to Problem

A working machine according to one aspect of the present invention includes: a posture detection device attached to a blade of a soil discharging device provided in front of a machine body; a reception device that receives position information of the blade from the outside; and a controller that communicates with the posture detection device and the reception device, in which the controller is arranged in front of a driver's seat in an operating part provided in the machine body.

A working machine according to another aspect of the present invention includes: an operating part that includes a driver's seat and allows boarding from a first side in a left-right direction; a pair of operation levers installed on both left and right sides of the driver's seat; and a first monitor and a second monitor installed in the operating part, in which the first monitor and the second monitor are arranged on a front of side and on a second side with respect to a grip part of the operation lever on the second side in the left-right direction out of the pair of operation levers, and are arranged to be shifted in an upper-lower direction.

### ADVANTAGEOUS EFFECTS OF INVENTION

It is possible to reduce the possibility that the lateral view field of the operator seated on the driver's seat is obstructed due to the arrangement of the controller.

Furthermore, even when the plurality of monitors are installed in the operating part, the visibility of each of the plurality of monitors can be ensured. Moreover, it is possible to reduce the possibility of erroneous contact with the operation lever when the operator operates the plurality of monitors.

### BRIEF DESCRIPTION OF DRAWINGS

FIG. 1 is a side view illustrating a schematic configuration of a hydraulic excavator that is an example of a working machine according to the present invention;

FIG. 2 is a block diagram illustrating an electrical configuration for performing blade machine control;

FIG. 3 is a perspective view illustrating a configuration of a front side of a lower traveling body of the hydraulic excavator;

FIG. 4 is a rear view of an upper turning body of the hydraulic excavator as viewed from behind;

FIG. 5 is a plan view of the upper turning body in a state where illustration of an eaves part of a canopy is omitted;

FIG. 6 is a perspective view of an operating part of the hydraulic excavator as viewed from the left rear;

FIG. 7 is a perspective view of the operating part as viewed from the right front;

FIG. 8 is a perspective view of the operating part as viewed from the left front;

FIG. 9A is a perspective view of the operating part as viewed from the left front in a state where a lid of a housing part is removed;

FIG. 9B is an enlarged plan view illustrating the operating part;

FIG. 10A is a perspective view of the housing part as viewed from the right rear lower side; and

FIG. 10B is a left side view of the operating part.

### DESCRIPTION OF EMBODIMENTS

An embodiment of the present invention will be described below with reference to the drawings.

### 1. Outline of Working Machine

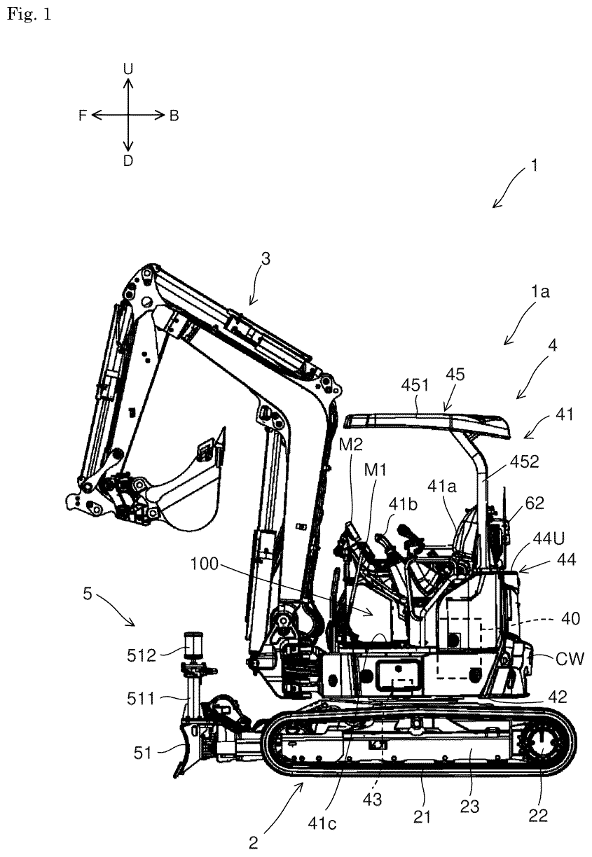

FIG. 1 is a side view illustrating a schematic configuration of a hydraulic excavator 1 that is an example of a working machine according to the present embodiment. The hydraulic excavator 1 includes a lower traveling body 2, working equipment 3, and an upper turning body 4.

Here, in this description, each direction is described according to the following definition. First, a direction in which an operator (an operating person or a driver) sitting on a driver's seat 41a of the upper turning body 4 faces the front is defined as the front, and the opposite direction is defined as the rear. Accordingly, in a state where the upper turning body 4 is not turning with respect to the lower traveling body 2 (turning angle: 0°), a front-rear direction of the upper turning body 4 matches with a direction in which the lower traveling body 2 moves forward and backward. Furthermore, a left side as viewed from the operator sitting on the driver's seat 41a is referred to as “left”, and a right side is referred to as “right”. Furthermore, a gravity direction perpendicular to the front-rear direction and the left-right direction is defined as an upper-lower direction, an upstream side in the gravity direction is defined as “up”, and a downstream side is defined as “down”. The drawings illustrate the hydraulic excavator 1 in a state where the upper turning body 4 is not turning with respect to the lower traveling body 2. Furthermore, in the drawings, as necessary, the front is denoted by a symbol “F”, the rear is denoted by a symbol “B”, the left side is denoted by a symbol “L”, the right side is denoted by a symbol “R”, the upper side is denoted by a symbol “U”, and the lower side is denoted by a symbol “D”.

In this specification, the lower traveling body 2 and the upper turning body 4 may be collectively referred to as a machine body 1a. Furthermore, in this specification, unless otherwise specified, a first side in the left-right direction is described as the left side, and a second side is described as the right side. Note that the relationship between the first side and the second side may be reversed. That is, the first side in the left-right direction may be the right side, and the second side may be the left side.

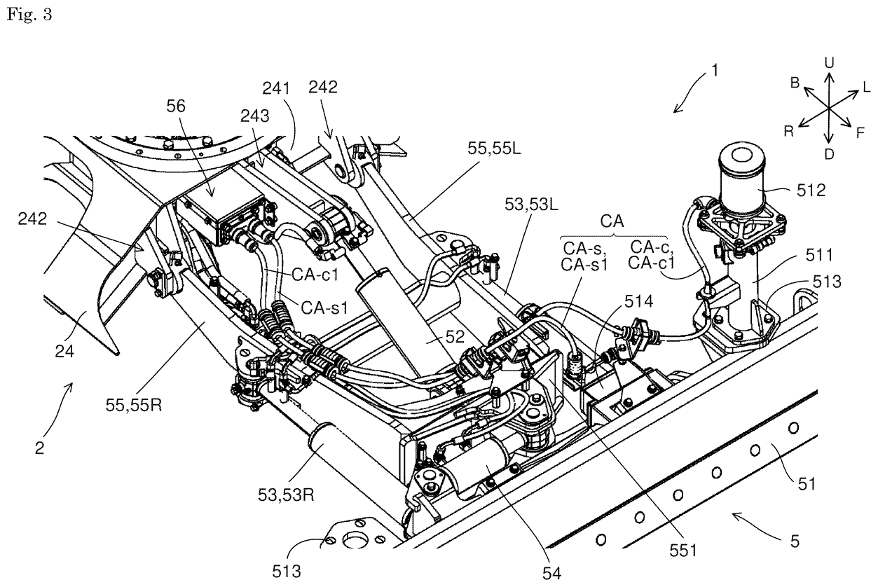

The lower traveling body 2 is a support body (lower body) that supports the upper turning body 4. The lower traveling body 2 includes a pair of left and right crawlers 21 and a pair of left and right traveling motors 22. Each of the traveling motors 22 is a hydraulic motor. The left and right traveling motors 22 drive the left and right crawlers 21, respectively, so that the hydraulic excavator 1 can be moved forward and backward. The left and right traveling motors 22 are supported by left and right side frames 23, respectively. Each of the side frames 23 extends in the front-rear direction, is arranged on both of the left and right sides of a center frame 24 (see FIG. 3), and is supported by the center frame 24.

In front of the machine body 1a, more specifically, on the front side of the lower traveling body 2, the soil discharging device 5 for performing ground leveling work is provided. The soil discharging device 5 includes a blade 51. On the left side of the blade 51, a target prism 512 is provided via a pole 511. The target prism 512 is provided to implement blade machine control. Note that details of the blade machine control including the target prism 512 will be described later.

The working equipment 3 is a working device that performs excavation work of earth and sand. The working equipment 3 is provided to a front part of the upper turning body 4, and performs the excavation work by rotating in the upper-lower direction or the front-rear direction.

In the present embodiment, the working equipment 3 has a crane function. The crane function refers to a function of lifting and lowering a suspended load. In order to implement such a crane function, the working equipment 3 includes a hook (not illustrated). The hook is provided so as to be capable of changing its posture between a stored state and an unfold state. By unfolding the hook, it is possible to suspend the load on the hook via a chain or the like.

The upper turning body 4 is an upper body that is located above the lower traveling body 2. The upper turning body 4 is supported turnably with respect to the lower traveling body 2. An operating part 41, a turning frame 42, a turning motor 43, and a machine room 44 are arranged in the upper turning body 4. The upper turning body 4 turns via a turning bearing (not illustrated) by driving the turning motor 43 that is a hydraulic motor. In addition to an engine 40 that provides power to each unit, a plurality of hydraulic pumps (not illustrated) are arranged inside the upper turning body 4 (particularly, the machine room 44). Furthermore, a counterweight CW for balancing with the working equipment 3 in the front-rear direction is provided in a rear part of the upper turning body 4.

The respective hydraulic pumps supply hydraulic oil (pressure oil) to the hydraulic motors (for example, the left and right traveling motors 22 and the turning motor 43) and hydraulic cylinders via hydraulic pipes. The hydraulic cylinders include a lift cylinder 52 (see FIG. 3) and the like to be described later. The hydraulic motor and the hydraulic cylinder driven by the hydraulic oil supplied from any of the hydraulic pumps are also collectively referred to as a hydraulic actuator.

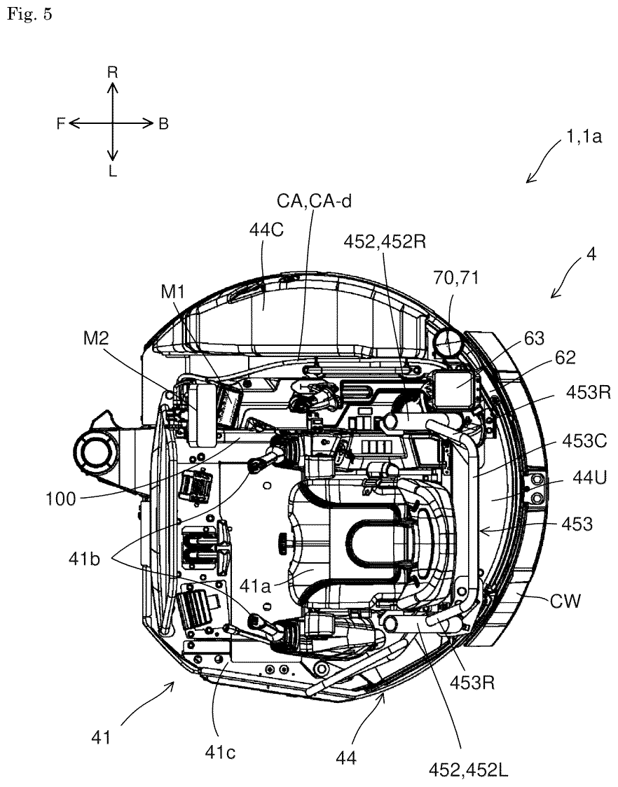

The driver's seat 41a is arranged in the operating part 41. Various operation levers 41b are arranged around the driver's seat 41a. An entry and exit part 41c is provided on the left side of the operating part 41 (see also FIG. 5). That is, the operating part 41 includes the entry and exit part 41c on the first side in the left-right direction. The entry and exit part 41c is a part (entry and exit) that serves as a passage for the operator to enter and exit the operating part 41. The operator gets on the operating part 41 from the entry and exit part 41c, sits on the driver's seat 41a, and operates the operation levers 41b, thereby driving a predetermined hydraulic actuator. After completion of work by the hydraulic excavator 1, the operator gets off the operating part 41 through the entry and exit part 41c.

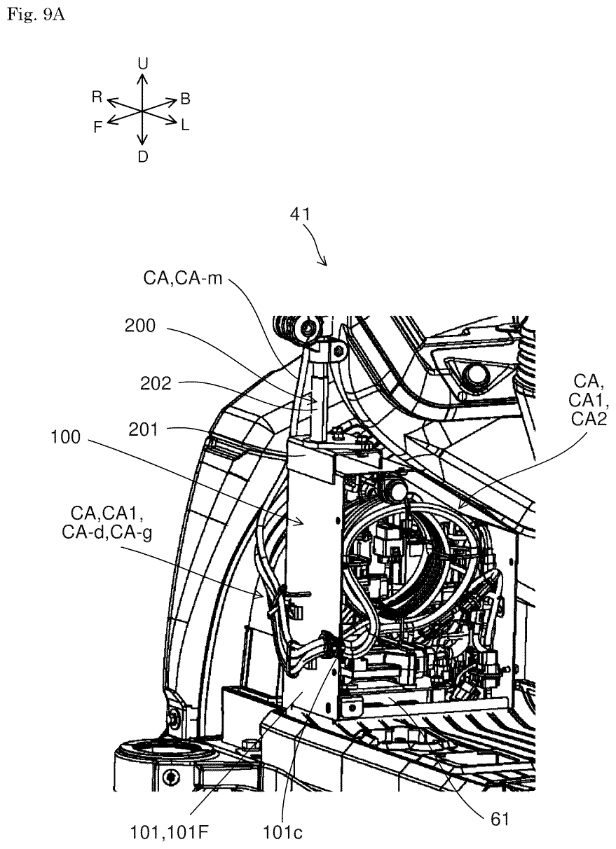

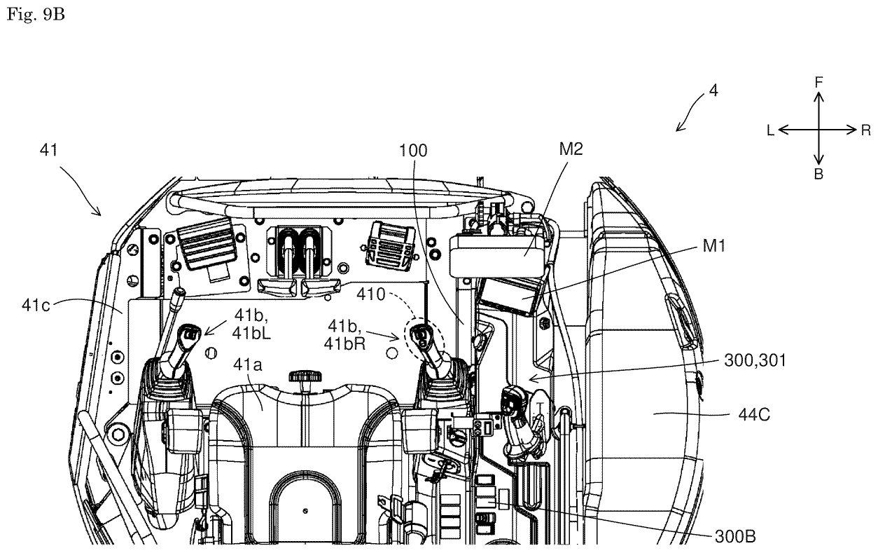

Furthermore, in another aspect, the operation levers 41b for operating the working equipment 3 are provided particularly on the left and right sides with the driver's seat 41a interposed therebetween (see also FIG. 5). Note that, in a case where it is necessary to particularly distinguish the left and right operation levers 41b, the operation lever 41b arranged on the left side with respect to the driver's seat 41a is also referred to as a left operation lever 41bL (see FIG. 9B), and the operation lever 41b arranged on the right side with respect to the driver's seat 41a is also referred to as a right operation lever 41bR (see FIG. 9B). Then, the left operation lever 41bL and the right operation lever 41bR are also collectively referred to as a pair of operation levers 41b.

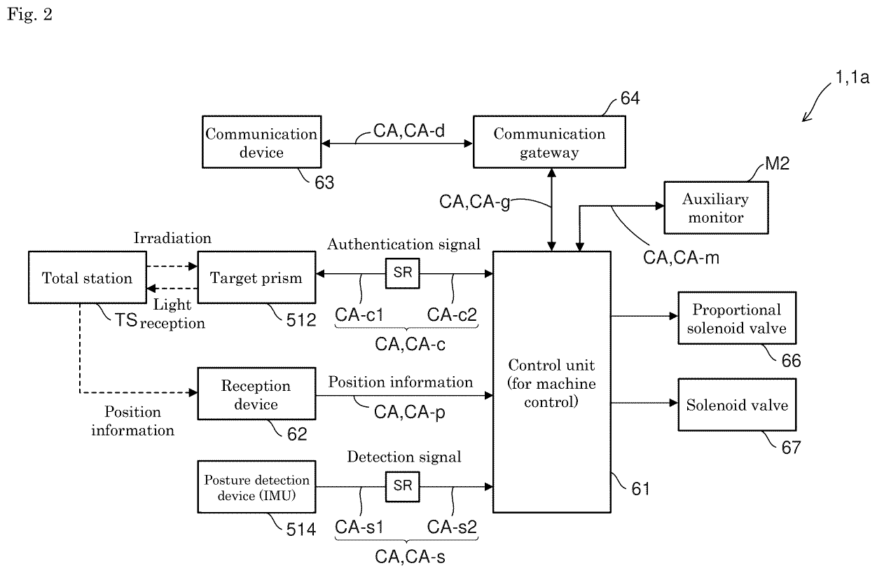

A housing part 100 is arranged in the operating part 41. The housing part 100 is a box. The housing part 100 houses a control unit 61 (see FIG. 2) and the like to be described later that perform the blade machine control. Note that details of the arrangement of the control unit 61 will be described later.

Furthermore, in another aspect, the entry and exit part 41c is provided on the left side of the operating part 41 (see also FIG. 5). The entry and exit part 41c is a part (entry and exit) that serves as a passage for the operator to enter and exit the operating part 41. The operator gets on the operating part 41 from the entry and exit part 41c, sits on the driver's seat 41a, and operates the operation levers 41b and the like, thereby driving a predetermined hydraulic actuator. After completion of work by the hydraulic excavator 1, the operator gets off the operating part 41 through the entry and exit part 41c.

As described above, the hydraulic excavator 1 of the present embodiment includes the operating part 41 that allows boarding from the first side in the left-right direction, and the pair of operation levers 41b. The operating part 41 includes the driver's seat 41a. The pair of operation levers 41b is installed on both the left and right sides of the driver's seat 41a.

The housing part 100 is arranged on the right side of the operating part 41 and in front of the driver's seat 41a. The housing part 100 is a box. The housing part 100 houses a control unit 61 (see FIG. 2) and the like to be described later that perform the blade machine control.

In the operating part 41, a main monitor M1 and an auxiliary monitor M2 are arranged above the housing part 100. The main monitor M1 and the auxiliary monitor M2 display various types of information. For example, the main monitor M1 displays various settings in the hydraulic excavator 1, a remaining amount of fuel, a hour meter, an image captured by a monitoring camera when the monitoring camera is mounted, and the like. That is, information to be presented to the operator when the hydraulic excavator 1 is used is displayed on the main monitor M1. On the other hand, the auxiliary monitor M2 displays information to be presented to the operator when the blade machine control is performed. Examples of the information include information indicating a position of a work surface and the blade 51.

Furthermore, in another aspect, the main monitor M1 and the auxiliary monitor M2 are configured to be able to receive an instruction input by the operator. For example, the main monitor M1 and the auxiliary monitor M2 are provided with an input unit that receives an instruction input by the operator. The input unit includes, for example, a physical button or a touch panel. When the operator operates the input unit, for example, it is possible to switch on/off of a display, switch a display screen, and the like. When the main monitor M1 is a first monitor and the auxiliary monitor M2 is a second monitor, it can be said that the hydraulic excavator 1 of the present embodiment includes the first monitor and the second monitor installed in the operating part 41. Note that details of the arrangement of the main monitor M1 and the auxiliary monitor M2 will be described later.

The operating part 41 includes a canopy 45. The canopy 45 is provided vertically on a rear upper part of the machine room 44 and covers at least the upper side of the driver's seat 41a. More specifically, the canopy 45 includes an eaves part 451 and support columns 452. The eaves part 451 is arranged above the driver's seat 41a of the operating part 41. The support columns 452 are provided on an upper surface part 44U of the machine room 44. The upper surface part 44U is provided behind the driver's seat 41a. The support columns 452 extend upward from the upper surface part 44U and then bend forward to extend to the eaves part 451 to support the eaves part 451. That is, the support columns 452 support the eaves part 451 from behind the driver's seat 41a.

On an upper surface of the machine room 44, two support columns 452 are provided apart from each other in the left-right direction. That is, the hydraulic excavator 1 includes the pair of support columns 452 arranged side by side in the left-right direction. Such a canopy 45 is also referred to as a two-column canopy. Note that the canopy 45 may be configured to support the eaves part 451 with three or more support columns 452.

### 2. Regarding Blade Machine Control

FIG. 2 is a block diagram illustrating an electrical configuration for performing blade machine control in the hydraulic excavator 1. FIG. 3 is a perspective view illustrating a configuration of the front side of the lower traveling body 2.

The blade machine control refers to control of automatically adjusting a posture (a height position and an angle) of the blade 51 based on three-dimensional data of ground to be worked on and position information of the blade 51. Hereinafter, the blade machine control is also simply referred to as machine control. In the present embodiment, the hydraulic excavator 1 includes the above-described target prism 512 to implement such machine control.

The target prism 512 includes a 360° prism. The 360° prism can reflect light in a direction parallel to incident light even when the light is incident from any direction. The target prism 512 is a target whose position is measured by a total station TS to be described later. The target prism 512 is attached to an upper part of the pole 511 and attached to the blade 51 with the pole 511 interposed therebetween.

As illustrated in FIG. 3, the pole 511 is attached to an upper surface of a mounting base 513 using a fastening member such as a bolt. The mounting base 513 is provided at two positions near a left end and near a right end of the blade 51 by welding or the like. Accordingly, the pole 511 in the state of holding the target prism 512 is selectively attachable to one of the left and right mounting bases 513. Although an example where the pole 511 is attached to the left mounting base 513 as illustrated in FIG. 3 is described in the present embodiment, the pole 511 may be attached to the right mounting base 513.

The total station TS (see FIG. 2) is installed at or near a work site of the hydraulic excavator 1. The total station TS includes a known electronic distance measurement/angle measurement device that uses light. The total station TS irradiates the target prism 512 with light, receives the light reflected by the target prism 512, and thereby measures a vertical angle, a horizontal angle, and a distance at which the target prism 512 is located. Thus, three-dimensional position coordinates of the target prism 512 are acquired by calculation.

The total station TS is configured as an automatic tracking type, and has a function of automatically tracking a change in the position of the target prism 512. The total station TS acquires the change in the position of the target prism 512 in real time while tracking the target prism 512. The relative positional relationship between the target prism 512 and the blade 51 is determined. Therefore, the total station TS can acquire the position information of the blade 51 to which the target prism 512 is attached by acquiring the position coordinates (position information) of the target prism 512.

The hydraulic excavator 1 is provided with the control unit 61 illustrated in FIG. 2. The control unit 61 is a controller for machine control, and is configured using, for example, an electronic control unit that is also referred to as an Electronic Control Unit (ECU). The control unit 61 can acquire the position information (the position information of the blade 51) of the target prism 512 acquired by the total station TS via a reception device 62 including an antenna and the like.

The target prism 512 is connected to the control unit 61 via an authentication cable CA-c. A signal for authentication is transmitted and received between the target prism 512 and the control unit 61 via the authentication cable CA-c. Thus, the control unit 61 can reliably receive only the position information from the specific total station TS via the reception device 62. Communication between the total station TS and the reception device 62 is performed wirelessly, for example. The signal (position information) received by the reception device 62 is transmitted to the control unit 61 via a position information transmission cable CA-p. Each of the authentication cable CA-c and the position information transmission cable CA-p is a type of cable CA.

The authentication cable CA-c includes a first authentication cable CA-c1 and a second authentication cable CA-c2. The first authentication cable CA-c1 connects the target prism 512 and a slip ring SR via a relay unit 56 (see FIG. 3). The relay unit 56 is fixed to a front wall part 241 of the center frame 24 using a fastening member such as a bolt. The slip ring SR is provided at a central part of the center frame 24 and transmits an electric signal between the lower traveling body 2 and the upper turning body 4. The second authentication cable CA-c2 is provided in the upper turning body 4 and connects the slip ring SR and the control unit 61.

The hydraulic excavator 1 further includes a posture detection device 514. The posture detection device 514 includes, for example, an Inertial Measurement Unit (IMU). The inertial measurement unit is a unit that includes a three-axis gyro sensor and a three-direction accelerometer.

As illustrated in FIG. 3, the posture detection device 514 is attached to a rear part of the blade 51. In the present embodiment, the posture detection device 514 is attached closer to the target prism 512 side (left side) than the center in the left-right direction of the blade 51. The posture detection device 514 can detect the position (three-dimensional position) and the acceleration in the left-right direction, the front-rear direction, and the upper-lower direction of the blade 51. Furthermore, an inclination angle in the left-right direction, the front-rear direction, and the upper-lower direction of the blade 51 can be detected based on information of the above acceleration. That is, the posture detection device 514 can detect the posture of the blade 51.

As illustrated in FIG. 2, the posture detection device 514 is connected to the control unit 61 via a detection signal transmission cable CA-s. Thus, the control unit 61 can acquire a detection signal output from the posture detection device 514, that is, the posture information of the blade 51 via the detection signal transmission cable CA-s. The detection signal transmission cable CA-s is a type of cable CA.

The detection signal transmission cable CA-s includes a first detection signal transmission cable CA-s1 and a second detection signal transmission cable CA-s2. The first detection signal transmission cable CA-s1 connects the posture detection device 514 and the slip ring SR via the relay unit 56. The second detection signal transmission cable CA-s2 is provided in the upper turning body 4 and connects the slip ring SR and the control unit 61.

As described above, the hydraulic excavator 1 of the present embodiment includes the posture detection device 514 attached to the blade 51 of the soil discharging device 5 provided in front of the machine body 1a, the reception device 62 that receives the position information of the blade 51 from the outside (here, the total station TS), and the control unit 61 serving as the controller that communicates with the posture detection device 514 and the reception device 62. In particular, the hydraulic excavator 1 includes the control unit 61 serving as the controller to which the position information of the blades 51 of the soil discharging device 5 provided in front of the machine body 1a is input.

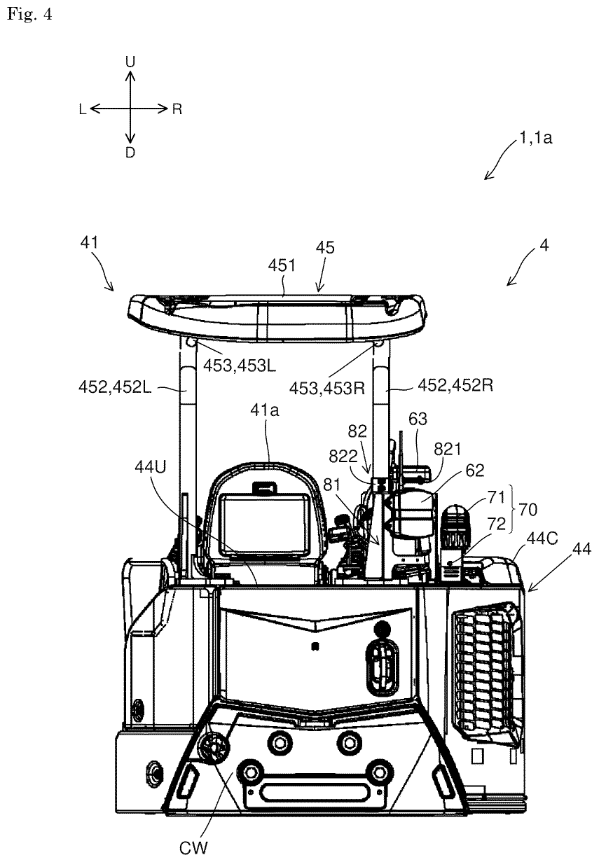

The hydraulic excavator 1 further includes a communication device 63. The communication device 63 is arranged, for example, on the right side of the driver's seat 41a (see FIG. 4). The communication device 63 includes, for example, a communication antenna capable of transmitting and receiving a signal. Thus, the communication device 63 can communicate with an external terminal device and receive (acquire) predetermined information from the terminal device. For example, three-dimensional data of the work surface can be considered as the predetermined information. The predetermined information acquired from the outside by the communication device 63 is transmitted to the control unit 61 via a communication gateway 64. Furthermore, information can also be transmitted from the hydraulic excavator 1 to the outside via the communication device 63.

The communication gateway 64 is a relay device that relays communication between the communication device 63 and the control unit 61, and can be configured using, for example, an ECU. The communication device 63 and the communication gateway 64 are connected via a data transmission cable CA-d. Furthermore, the communication gateway 64 and the control unit 61 are connected via a communication cable CA-g. Each of the data transmission cable CA-d and the communication cable CA-g is a type of cable CA.

As described above, the hydraulic excavator 1 includes the communication device 63, arranged on the second side of the driver's seat 41a in the left-right direction, and the communication gateway 64 communicably connected to the communication device 63.

Further, the auxiliary monitor M2 is connected to the control unit 61 via a monitor cable CA-m. Information to be displayed on the auxiliary monitor M2 (for example, information indicating the work surface and the position of the blade 51) is transmitted from the control unit 61 to the auxiliary monitor M2 via the monitor cable CA-m and displayed on the auxiliary monitor M2. The monitor cable CA-m is a type of cable CA. As described above, the hydraulic excavator 1 includes the auxiliary monitor M2 that displays the information output from the control unit 61 serving as the controller.

The control unit 61 incorporates a storage unit. The control unit 61 operates according to an operation program stored in the storage unit. The storage unit is a memory that stores various types of information, and includes, for example, a Random Access Memory (RAM), a Read Only Memory (ROM), a hard disk, a Solid State Drive (SSD), a nonvolatile memory, and the like. The storage unit stores, for example, the operation program for machine control, the received three-dimensional data of the work surface, and the like.

Accordingly, by executing the above operation program, the control unit 61 can control a proportional solenoid valve 66 and a solenoid valve 67 based on the position information (position information of the blade 51) of the target prism 512 acquired via the total station TS, the posture information of the blade 51 acquired from the posture detection device 514, and the three-dimensional data of the work surface.

The proportional solenoid valve 66 is provided to control a direction switching valve included in a control valve (not illustrated). The above direction switching valve includes the direction switching valve for the lift cylinder 52 illustrated in FIG. 3, and a direction switching valve shared by angle cylinders 53 and a tilt cylinder 54. The former direction switching valve for the lift cylinder 52 refers to a direction switching valve for controlling a flow rate and a flow direction of the hydraulic oil supplied from the hydraulic pump (not illustrated) to the lift cylinder 52. The latter direction switching valve refers to a direction switching valve for controlling the flow rate and the flow direction of the hydraulic oil supplied from the hydraulic pump to the angle cylinder 53 or the tilt cylinder 54. The angle cylinders 53 and the tilt cylinder 54 are connected with the solenoid valve 67 via separate pipes.

The solenoid valve 67 is a switching valve for switching a supply destination of the hydraulic oil from the hydraulic pump to the angle cylinders 53 or the tilt cylinder 54. That is, the solenoid valve 67 switches an oil passage to one of the angle cylinders 53 and the tilt cylinder 54 based on an electric signal (control signal) from the control unit 61.

The lift cylinder 52 illustrated in FIG. 3 is a hydraulic cylinder that lifts and lowers the blade 51 in the upper-lower direction. The angle cylinder 53 is a hydraulic cylinder that swings the left and right end parts of the blade 51 in the front-rear direction. The tilt cylinder 54 is a hydraulic cylinder that swings the left and right end parts of the blade 51 in the upper-lower direction. Accordingly, by controlling the proportional solenoid valve 66 and the solenoid valve 67 based on the position information of the target prism 512 and the like described above, the control unit 61 can extend and contract at least one of the lift cylinder 52, the angle cylinder 53, and the tilt cylinder 54. Thus, it is possible to move the blade 51 along the work surface by automatically adjusting the position in the upper-lower direction, the inclination angle (angle) in the front-rear direction, and the inclination angle (tilt) in the left-right direction of the blade 51.

### 3. Regarding Support Structure of Blade

Next, a support structure of the blade 51 will be described. As illustrated in FIG. 3, the above-described lift cylinder 52 is arranged between a pair of left and right arms 55, that is, between a left arm 55L and a right arm 55R. The left arm 55L and the right arm 55R are attached to the lower traveling body 2 and extend forward.

More specifically, arm support parts 242 are provided to a front wall part 241 of the center frame 24 of the lower traveling body 2. The arm support part 242 has a structure in which the arms 55 are sandwiched between a pair of plate-like members to support the arms 55 rotatably in the upper-lower direction. The arm support parts 242 are provided to protrude forward from different positions in the left-right direction of the front wall part 241. The left arm 55L and the right arm 55R are supported by the left and right arm support parts 242, respectively, and extend toward the blade 51 in the front. Distal ends of the left arm 55L and the right arm 55R are coupled to a left end part and a right end part of a coupling part 551 extending in the left-right direction, respectively. The blade 51 is arranged in front of the coupling part 551, and is rotatably attached to the coupling part 551 via a rotation shaft extending in the front-rear direction.

A lift cylinder support part 243 is provided to a central part of the front wall part 241 in the left-right direction. The lift cylinder support part 243 is arranged between the left and right arm support parts 242 and is provided to protrude forward from the front wall part 241. The left and right arm support parts 242 are provided at symmetrical positions in the left-right direction with respect to the lift cylinder support part 243.

The lift cylinder support part 243 has a structure in which one end part (for example, rod end part) of the lift cylinder 52 is sandwiched between the pair of plate-like members to support the lift cylinder 52 rotatably in the upper-lower direction. The other end part of the lift cylinder 52 is supported on a back surface of the coupling part 551 rotatably in the upper-lower direction.

By supplying/discharging (supplying or discharging) the hydraulic oil to and from the lift cylinder 52 through a lift hydraulic hose, the lift cylinder 52 extends or contracts. Thus, the blade 51 moves up and down in the upper-lower direction.

The angle cylinder 53 includes a right angle cylinder 53R and a left angle cylinder 53L. The right angle cylinder 53R is arranged on the right side of the right arm 55R. One end part (rod-side end part) of the right angle cylinder 53R is supported by the right arm 55R. The other end part (bottom-side end part) of the right angle cylinder 53R is supported on a back surface of the blade 51 and at a position closer to the right side than the center in the left-right direction.

The left angle cylinder 53L is arranged on the left side of the left arm 55L. One end part (rod-side end part) of the left angle cylinder 53L is supported by the left arm 55L. The other end part (bottom-side end part) of the left angle cylinder 53L is supported on the back surface of the blade 51 and at a position closer to the left side than the center in the left-right direction.

In a case where the oil passage from the hydraulic pump is switched to the angle cylinder 53 side (not the tilt cylinder 54 side) by the above-described solenoid valve 67 (see FIG. 2), the right angle cylinder 53R extends or contracts by supplying or discharging the hydraulic oil to or from the right angle cylinder 53R through a right angle hydraulic hose. By supplying or discharging the hydraulic oil to or from the left angle cylinder 53L through a left angle hydraulic hose, the left angle cylinder 53L extends or contracts.

Note that the solenoid valve 67 and the right angle cylinder 53R are connected by the right angle hydraulic hose. On the other hand, the left angle hydraulic hose branches from the right angle hydraulic hose and is connected to the left angle cylinder 53L. However, connection destinations (the bottom side and the rod side) of the right angle hydraulic hose with respect to the right angle cylinder 53R and connection destinations (the bottom side and the rod side) of the left angle hydraulic hose with respect to the left angle cylinder 53L are set such that the left angle cylinder 53L contracts when the right angle cylinder 53R extends and the left angle cylinder 53L extends when the right angle cylinder 53R contracts.

Accordingly, for example, when the right angle cylinder 53R contracts and the left angle cylinder 53L extends, the blade 51 is inclined in the right direction with respect to a traveling direction of the hydraulic excavator 1. That is, the blade 51 is inclined such that the left end is located closer to the front than the right end. Conversely, when the right angle cylinder 53R extends and the left angle cylinder 53L contracts, the blade 51 is inclined in the left direction with respect to the traveling direction of the hydraulic excavator 1. That is, the blade 51 is inclined such that the right end is located closer to the front than the left end.

Although the number of the angle cylinders 53 is two (the left angle cylinder 53L and the right angle cylinder 53R) in the present embodiment, only one of the left and right angle cylinders may be provided. In this regard, from a viewpoint of rotating the blade 51 in the front-rear direction in a well-balanced manner, the number of the angle cylinders 53 is desirably two as in the present embodiment.

The tilt cylinder 54 is arranged between the coupling part 551 and the blade 51 and extends and contracts in the left-right direction. One end part (for example, left end part) of the tilt cylinder 54 is supported on a front surface part of the coupling part 551 and at a position closer to the upper side than the rotation shaft of the blade 51 (extending in the front-rear direction). The other end part (for example, right end part) of the tilt cylinder 54 is supported on the back surface of the blade 51 and at a position closer to the right side than the center in the left-right direction.

The tilt cylinder 54 and the solenoid valve 67 are connected by a tilt hydraulic hose. When the solenoid valve 67 switches the oil passage from the hydraulic pump to the tilt cylinder 54 side (not the angle cylinder 53 side), the tilt cylinder 54 extends or contracts by supplying or discharging the hydraulic oil from the solenoid valve 67 to or from the tilt cylinder 54 through the tilt hydraulic hose. When the tilt cylinder 54 extends, for example, the blade 51 rotates in a direction in which the right end is lowered and the left end is raised. Conversely, when the tilt cylinder 54 contracts, the blade 51 rotates in a direction in which the right end is raised and the left end is lowered.

### 4. Supplement Regarding Configuration of Upper Turning Body

Next, description of the above-described configuration of the upper turning body 4 will be supplemented. FIG. 4 is a rear view of the upper turning body 4 as viewed from behind. As illustrated in the drawing, the operating part 41 is provided to be closer to the left side than a center position in the upper turning body 4 in the left-right direction. That is, the operating part 41 is provided on the first side in the left-right direction of the machine body 1a (the upper turning body 4).

A cover member 44C is provided on the second side in the left-right direction of the machine body 1a and on the right side of the operating part 41. The cover member 44C is provided rotatably in the upper-lower direction with a rear end as a rotation fulcrum. As the cover member 44C is rotated and opened, it is possible to perform maintenance of components housed inside. Examples of the components include a hydraulic oil tank and a low-voltage battery, but are not limited to these components.

Furthermore, the pair of support columns 452 of the canopy 45 includes a left support column 452L and a right support column 452R. The left support column 452L is arranged on the left side in the operating part 41 and supports the left side of the eaves part 451. The right support column 452R is arranged on the right side of the left support column 452L and supports the right side of the eaves part 451. As described above, the pair of support columns 452 includes the left support column 452L as a first support column arranged on the first side in the left-right direction and the right support column 452R as a second support column arranged on the second side in the left-right direction with respect to the left support column 452L.

FIG. 5 is a plan view of the upper turning body 4 in a state where illustration of the eaves part 451 of the canopy 45 is omitted. The left support column 452L and the right support column 452R are coupled by a lateral support column 453. The lateral support column 453 couples the left support column 452L and the right support column 452R at their respective upper parts. Thus, a rear view field of the operator seated on the driver's seat 41a is not blocked by the lateral support column 453, and the view field is satisfactorily ensured.

The lateral support column 453 includes a central part 453C, a left coupling part 453L, and a right coupling part 453R. The central part 453C extends in the left-right direction. The left coupling part 453L extends obliquely forward to the left from a left end of the central part 453C and is coupled to the left support column 452L. The right coupling part 453R extends obliquely forward to the right from a right end of the central part 453C and is coupled to the right support column 452R. Since the lateral support column 453 is provided, the left support column 452L and the right support column 452R are reinforced. Thus, the eaves part 451 is stably supported by the left support column 452L and the right support column 452R.

An alarm device 70 is arranged on the right side of the right support column 452R in the upper surface part 44U of the upper turning body 4. That is, the hydraulic excavator 1 includes the alarm device 70 arranged on the second side in the left-right direction with respect to the right support column 452R which is the second support column. The alarm device 70 includes an alarm lamp 71 and an alarm buzzer 72.

The alarm lamp 71 is configured using, for example, a rotating light. The alarm lamp 71 is turned on in response to abnormality detection, thereby drawing attention to the surroundings. For example, when an overload is applied to the working equipment 3 in a crane operation, the alarm lamp 71 is turned on. The alarm buzzer 72 sounds, for example, during traveling of the hydraulic excavator 1, and draws attention to the surroundings during the traveling. In the present embodiment, the alarm buzzer 72 is arranged in the upper surface part 44U, and the alarm lamp 71 is arranged above the alarm buzzer 72. Note that the alarm lamp 71 may be arranged side by side with the alarm buzzer 72 in the upper surface part 44U.

### 5. Regarding Arrangement of Reception Device, Communication Gateway, and Communication Device

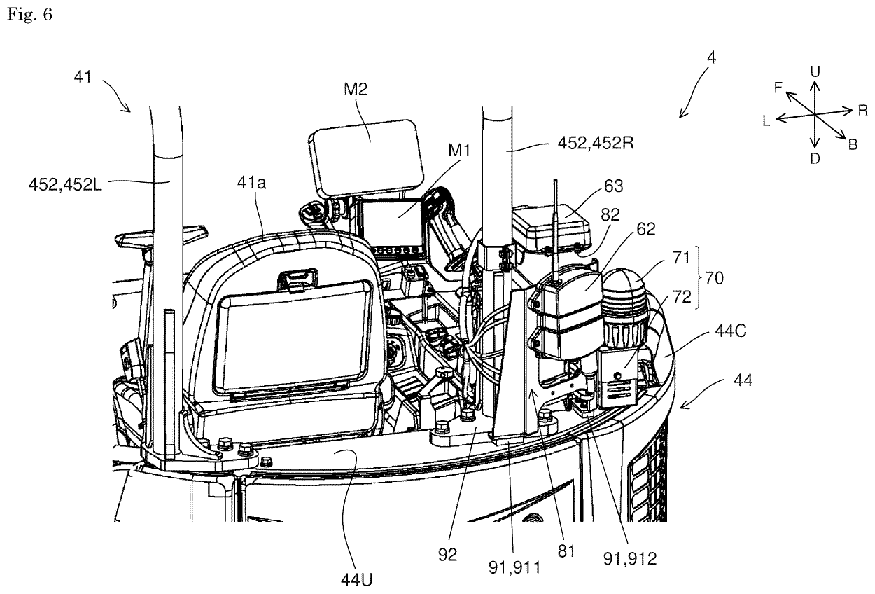

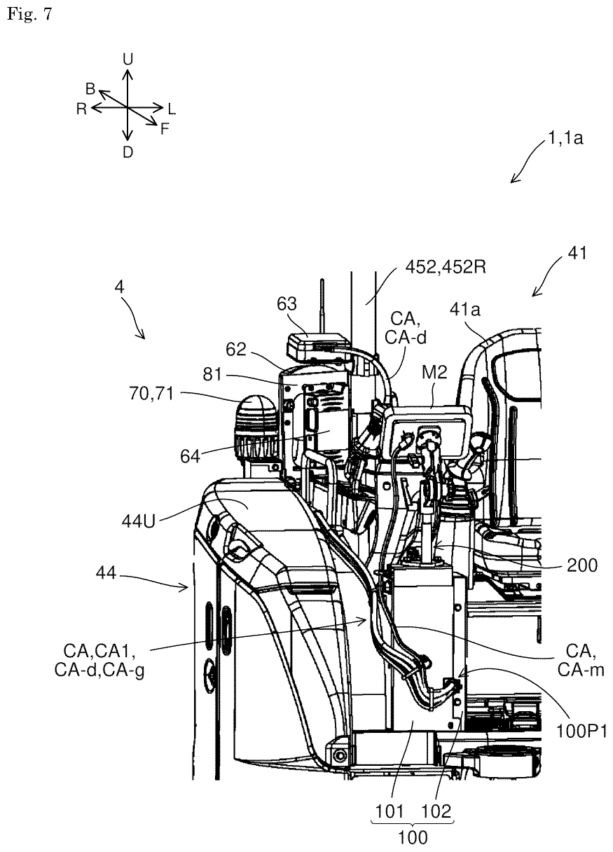

FIG. 6 is a perspective view of the operating part 41 as viewed from the left rear. FIG. 7 is a perspective view of the operating part 41 as viewed from the right front. The above-described reception device 62 is arranged on the rear of the pair of support columns 452 and is arranged to be shifted to the right side at the rear of the right support column 452R, that is, to the second side in the left-right direction. In the present embodiment, as illustrated in FIG. 4, a part of the reception device 62 is arranged so as to overlap the right support column 452R in rear view. Note that the reception device 62 may be arranged to be shifted to the right side of a right end of the right support column 452R.

Further, the reception device 62 is arranged apart from the right support column 452R. More specifically, as illustrated in FIGS. 4 to 6, the reception device 62 is attached to a first bracket 81. The first bracket 81 is fixed to the upper surface part 44U via first support parts 91 (see FIG. 6). On the other hand, the right support column 452R is fixed to the upper surface part 44U via a second support part 92. The reception device 62 and the right support column 452R are fixed to the upper surface part 44U by separate support parts (the first support part 91 and the second support part 92), respectively, thereby implementing a configuration in which the reception device 62 and the right support column 452R are arranged apart from each other.

As illustrated in FIG. 6, the first bracket 81 is arranged between the right support column 452R and the reception device 62, and is supported by the machine body 1a (the upper surface part 44U). In addition to the reception device 62, the communication gateway 64 is attached to the first bracket 81 as illustrated in FIG. 7. More specifically, the reception device 62 is attached to the rear side of the first bracket 81 (see FIG. 6). The communication gateway 64 is attached to the front side of the first bracket 81 (see FIG. 7). As a result, the communication gateway 64 is arranged between the right support column 452R and the reception device 62.

As illustrated in FIG. 6, the first support parts 91 are fixed to predetermined positions of the upper surface part 44U by welding or the like. The first support parts 91 are provided to support the first bracket 81 on the machine body 1a (particularly, the upper surface part 44U of the upper turning body 4). The first support parts 91 include a left first support part 911 and a right first support part 912. Each of the left first support part 911 and the right first support part 912 includes a metal block body. The left first support part 911 and the right first support part 912 are arranged apart from each other in the left-right direction on the upper surface part 44U. The right first support part 912 is arranged between the left first support part 911 and the alarm device 70 (for example, the alarm buzzer 72). The first bracket 81 is fixed at two parts, that is, the left first support part 911 and the right first support part 912 using fastening members such as bolts. Thus, the first bracket 81 is fixed to the upper surface part 44U via the first support parts 91 on the left side of the alarm device 70.

Furthermore, the second support part 92 is fixed to a predetermined position of the upper surface part 44U using a fastening member such as a bolt. The second support part 92 is provided to support the right support column 452R, which is the second support column, to the machine body 1a (particularly, the upper surface part 44U of the upper turning body 4). A lower end part of the right support column 452R is fixed to the second support part 92 by, for example, welding or the like. The left first support part 911 is provided at the rear of the second support part 92 to be adjacent to the second support part 92 in the upper surface part 44U. The right first support part 912 is arranged on the right side of the second support part 92.

As illustrated in FIGS. 4 and 6, the communication device 63 is attached to the second bracket 82. The second bracket 82 is attached to the right support column 452R. As illustrated in FIG. 4, the second bracket 82 includes a support frame 821 and a clamp member 822. The support frame 821 includes, for example, a metal flat plate having an opening at the center. The communication device 63 is fixed to an upper surface of the support frame 821 using a bolt or the like.

The support frame 821 is located on the right side of the clamp member 822 and is provided integrally with the clamp member 822. Note that the support frame 821 may be fastened to the clamp member 822 using a fastening member.

The clamp member 822 is a member that sandwiches the right support column 452R. A position (clamping position) at which the right support column 452R is sandwiched by the clamp member 822 can be appropriately adjusted in the upper-lower direction in which the right support column 452R extends. By adjusting the clamping position in the upper-lower direction, it is possible to adjust positions of the support frame 821 coupled to the clamp member 822 and the communication device 63 fixed to the support frame 821 in the upper-lower direction. The second bracket 82 is attached to the right support column 452R above the first bracket 81.

### 6A. Regarding Arrangement of Control Unit and Routing of Cable

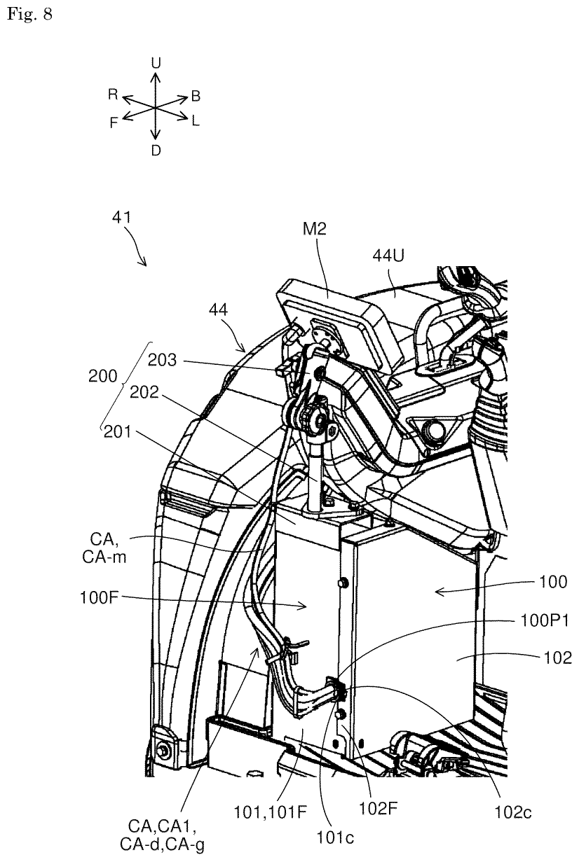

Next, details of the arrangement of the control unit 61 described above (see FIG. 2 and the like) will be described including the routing of the cables CA. FIG. 8 is a perspective view of the operating part 41 as viewed from the left front. FIG. 9A is a perspective view of the operating part 41 as viewed from the left front in a state where a lid 102 (see FIG. 8) to be described later of the housing part 100 is removed. The housing part 100 described above is arranged on the right side of the operating part 41. Furthermore, the housing part 100 is arranged in front of the driver's seat 41a as illustrated in FIG. 1. Furthermore, as illustrated in FIG. 9A, the control unit 61 is housed in the housing part 100. Accordingly, it can be said that the control unit 61 serving as the controller is arranged in front of the driver's seat 41a in the operating part 41 provided in the machine body 1a.

Since the control unit 61 is arranged in front of the driver's seat 41a, for example, even when the control unit 61 is arranged to be housed in the housing part 100, the housing part 100 can be arranged in front of the driver's seat 41a. That is, it is not necessary to arrange the housing part 100 on the right side of the driver's seat 41a. Thus, it is possible to reduce the possibility that the lateral view field (particularly, the view field on the right side) of the operator seated on the driver's seat 41a is obstructed by the housing part 100. That is, it is possible to reduce the possibility that the lateral view field of the operator is obstructed due to the arrangement of the control unit 61. Accordingly, it is possible to satisfactorily ensure the lateral view field of the operator even in the configuration in which the posture detection device 514 and the reception device 62 communicate with the control unit 61 (configuration in which the control unit 61 performs the machine control) as illustrated in FIG. 2.

In particular, the control unit 61 is arranged on a side opposite to the entry and exit part 41c (see FIG. 1) in the operating part 41 in the present embodiment. Specifically, the entry and exit part 41c is provided on the left side of the operating part 41 as described above. Therefore, the control unit 61 is provided on the right side of the operating part 41. That is, the control unit 61 is arranged on the second side in the left-right direction in the operating part 41. In this case, the housing part 100 that houses the control unit 61 is also arranged on the second side (right side) of the operating part 41 (see FIG. 5). Thus, there is no possibility that an entry and exit operation of the operator through the entry and exit part 41c is obstructed by the control unit 61 and the housing part 100. In this respect, the configuration in which the control unit 61 is arranged on the side opposite to the entry and exit part 41c in the left-right direction is effective.

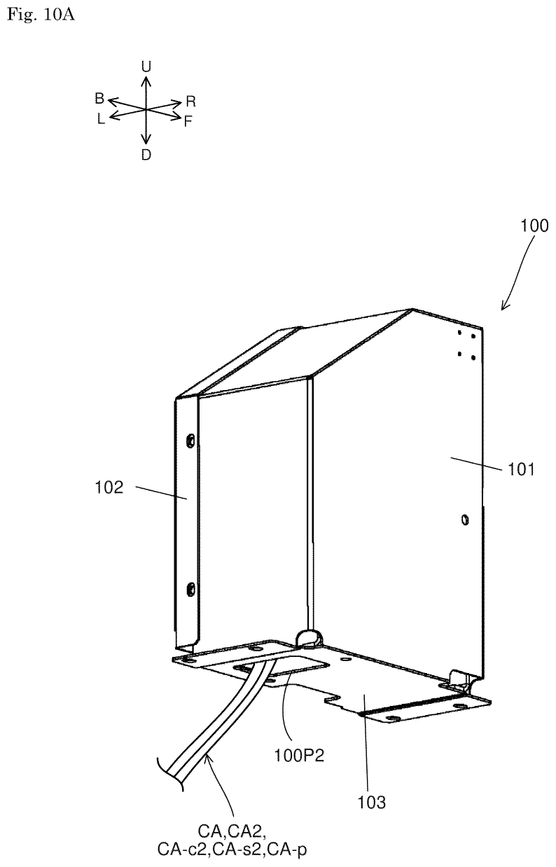

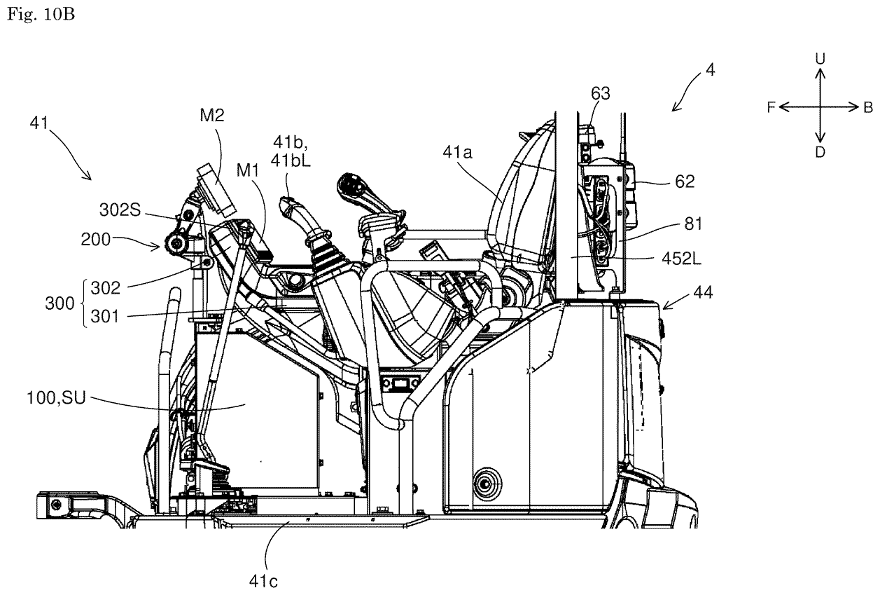

As illustrated in FIG. 8, the housing part 100 of the present embodiment includes, for example, a box body having a pentagonal left side surface and a pentagonal right side surface. Note that the shape of the housing part 100 is not limited to the shape of the present embodiment, and can be implemented in various shapes such as a rectangular parallelepiped. The housing part 100 includes a main body 101 and the lid 102. The main body 101 is a case that is opened on the left side and the lower side. The lid 102 is arranged on the left side of the main body 101, and is detachably fixed to the main body 101 using a fastening member such as a bolt. That is, the lid 102 covers the main body 101 from the left side, and is fixed by the fastening member. Note that the housing part 100 may be configured to include a door rotatable (openable/closable) with respect to the main body 101 instead of providing the lid 102. Note that the lower side of the main body 101 is closed by a bottom surface part 103 (see FIG. 10 A) to be described later.

As illustrated in FIG. 9A, the control unit 61 is arranged on the lower side in the main body 101 (the housing part 100). Then, the cables CA connected to the control unit 61 are housed above the control unit 61 in the housing part 100. That is, the housing part 100 houses the cables CA extending from the outside to the inside of the housing part 100 above the control unit 61.

In this configuration, the control unit 61 and the cables CA are simultaneously housed in one housing part 100. Thus, for example, the number of components (the number of housing parts) is reduced as compared with a configuration in which a housing part that houses the cables CA is provided separately from the housing part 100 that houses the control unit 61.

In the housing part 100, it is desirable to efficiently house the cables CA by effectively using a limited space in the housing part 100 without entangling of the cables CA. From this viewpoint, as illustrated in FIG. 9A, the cables CA are desirably housed in the housing part 100 in a wound state. Note that the cables CA may be folded back a plurality of times and housed in the housing part 100, for example.

Here, the cables CA housed in the housing part 100 include upper cables CA1. The upper cables CA1 are cables routed through the right side (the second side in the left-right direction) of the operating part 41. The upper cables CA1 are routed through a first opening 100P1 (see FIG. 8) to be described later of the housing part 100.

As illustrated in FIGS. 4, 6, and 7, in the present embodiment, the reception device 62, the communication device 63, and the communication gateway 64 are arranged at the rear or the right side of the right support column 452R. Accordingly, the position information transmission cable CA-p connecting the reception device 62 and the control unit 61 and the communication cable CA-g connecting the communication gateway 64 and the control unit 61 are routed from the rear to the front on the right side of the operating part 41 (see FIG. 7). However, the position information transmission cable CA-p extends downward on the way from the rear to the front on the right side of the operating part 41, and is connected to the control unit 61 through a second opening 100P2 to be described later of the housing part 100.

Furthermore, the communication device 63 and the communication gateway 64 are arranged at positions close to each other on the right side of the operating part 41 (see FIG. 6). On the other hand, the data transmission cable CA-d connecting the communication device 63 and the communication gateway 64 is configured using, for example, a long standard product. Therefore, the data transmission cable CA-d extending from the communication device 63 is directed forward through the right side of the operating part 41, and is once guided to the inside of the housing part 100 in which the control unit 61 is housed. Then, the data transmission cable CA-d extends rearward from the housing part 100 through the right side of the operating part 41 and is connected to the communication gateway 64. In this manner, the data transmission cable CA-d is also routed through the right side of the operating part 41 (see FIG. 7).

From the above, it can be said that at least the communication cable CA-g and the data transmission cable CA-d are included in the upper cables CA1 routed in the front-rear direction through the right side of the operating part 41.

In the configuration in which peripheral devices such as the communication device 63 are arranged on the right side of the operating part 41, the routing in which the cables CA (the upper cables CA1) extending from the communication device 63 and the like are guided to the housing part 100 through the right side of the operating part 41 is optimal. In this respect, the cables CA housed in the housing part 100 desirably include the upper cables CA1 passing through the right side of the operating part 41.

Furthermore, from a viewpoint of implementing the housing of the communication cable CA-g connecting the control unit 61 and the communication gateway 64 in the housing part 100, the upper cables CA1 desirably include the communication cable CA-g.

Furthermore, from a viewpoint of implementing the housing of the data transmission cable CA-d connecting the communication device 63 and the communication gateway 64 in the housing part 100, the upper cables CA1 desirably include the data transmission cable CA-d.

As described above, the auxiliary monitor M2 is arranged above the housing part 100. As illustrated in FIGS. 7 to 9A, such an arrangement is implemented by the auxiliary monitor M2 being supported on an upper part of the housing part 100 via a support structure part 200. As illustrated in FIG. 8, the support structure part 200 includes a support stay 201, a support stand 202, and a mounting part 203. The support stay 201 is fixed to the upper part of the housing part 100 by welding or the like to support the support stand 202. The support stand 202 extends upward and supports the mounting part 203 at an upper part. The mounting part 203 supports the auxiliary monitor M2. The mounting part 203 is configured to be able to adjust a posture (for example, a height position in the upper-lower direction, a rotation angle in the upper-lower direction, and the like) of the auxiliary monitor M2.

In order to satisfactorily ensure the visibility when the operator seated on the driver's seat 41a views the auxiliary monitor M2, the auxiliary monitor M2 is desirably arranged in front of the driver's seat 41a. From this viewpoint, the auxiliary monitor M2 is desirably supported by the housing part 100 (via the support structure part 200) arranged in front of the driver's seat 41a.

The auxiliary monitor M2 is connected to the control unit 61 housed in the housing part 100 via the monitor cable CA-m. In order to implement the optimal routing of the monitor cable CA-m, a part of the monitor cable CA-m is desirably housed in the housing part 100. That is, the cable CA housed in the housing part 100 desirably includes the monitor cable CA-m that connects the control unit 61 and the auxiliary monitor M2.

### 6B. Regarding Routing of Cable

Furthermore, in another aspect, as illustrated in FIG. 7, the position information transmission cable CA-p, the communication cable CA-g, and the data transmission cable CA-d are routed in the front-rear direction through the right side of the operating part 41. However, the position information transmission cable CA-p extends downward on the right side of the operating part 41 on the way from the rear to the front, and is routed through the second opening (not illustrated) to be described later of the housing part 100. Hereinafter, among the cables CA, the communication cable CA-g and the data transmission cable CA-d are also collectively referred to as the upper cables CA1. FIG. 8 is a perspective view of the operating part 41 as viewed from the left front. The upper cables CA1 are guided into the housing part 100 through the first opening 100P1 provided in a front surface part 100F of the housing part 100. Among the upper cables CA1, the communication cable CA-g is connected to the control unit 61 (see FIG. 2 and the like) arranged inside the housing part 100. Furthermore, the above-described monitor cable CA-m is also guided to the inside of the housing part 100 through the first opening 100P1 and connected to the control unit 61. On the other hand, among the upper cables CA1, the data transmission cable CA-d is routed through the first opening 100P1 in a reciprocating manner. Thus, even when the data transmission cable CA-d is configured using, for example, a long standard product, it is not necessary to bundle the data transmission cable CA-d outside the housing part 100, and it is possible to appropriately route the long data transmission cable CA-d. As illustrated in FIG. 8, the housing part 100 of the present embodiment includes, for example, a box body having a pentagonal left side surface and a pentagonal right side surface. Note that the shape of the housing part 100 is not limited to the shape of the present embodiment, and can be implemented in various shapes such as a rectangular parallelepiped. The housing part 100 includes a main body 101 and the lid 102. The main body 101 is a case that is opened on the left side and the lower side. The lid 102 is arranged on the left side of the main body 101, and is detachably fixed to the main body 101 using a fastening member such as a bolt. That is, the lid 102 covers the main body 101 from the left side, and is fixed by the fastening member. Note that the housing part 100 may be configured to include a door rotatable (openable/closable) with respect to the main body 101 instead of providing the lid 102. The lower side of the main body 101 is closed by a bottom surface part (not illustrated). The bottom surface part is provided with a second opening (not illustrated). Among the cables CA described above, the position information transmission cable CA-p, the second detection signal transmission cable CA-s2, and the second authentication cable CA-c2 (see FIG. 2) pass through the second opening and are connected to the control unit 61 inside the housing part 100. Accordingly, the position information transmission cable CA-p, the second detection signal transmission cable CA-s2, and the second authentication cable CA-c2 are also referred to as lower cables. In the housing part 100, it is desirable to efficiently house the cables CA by effectively using a limited space in the housing part 100 without entangling of the cables CA. From this viewpoint, the cables CA (the upper cables CA1, the monitor cable CA-m, and the lower cables) are desirably housed in the housing part 100 in a wound state. Note that the cables CA may be folded back a plurality of times and housed in the housing part 100, for example. Note that the position information transmission cable CA-p may be routed through the first opening 100P1 and connected to the control unit 61 inside the housing part 100. In this case, it can be said that the upper cables CA1 may include the position information transmission cable CA-p. Next, description of the front surface part 100F of the housing part 100 will be supplemented. As illustrated in FIG. 8, the front surface part 100F includes a main-body-side front surface part 101F and a lid-side front surface part 102F. The main-body-side front surface part 101F is a front wall of the main body 101. The lid-side front surface part 102F is a front wall of the lid 102. Note that the front surface part 100F includes a part where the main-body-side front surface part 101F and the lid-side front surface part 102F overlap each other when the lid 102 is put on the main body 101. A main-body-side cutout part 101c recessed rightward is provided at a left end edge of the body-side front surface part 101F. A lid-side cutout part 102c recessed leftward is provided at a right end edge of the lid-side front surface part 102F. The first opening 100P1 is formed of the main-body-side cutout part 101c and the lid-side cutout part 102c. That is, when the lid 102 is put on the main body 101, an opening region of the main-body-side cutout part 101c and an opening region of the lid-side cutout part 102c overlap each other. This overlapping region is the opening of the first opening 100P1.

### 7A. Regarding First Opening of Housing Part

Next, the above-described first opening 100P1 of the housing part 100 will be described. As illustrated in FIG. 8, the housing part 100 has the front surface part 100F. The front surface part 100F is the wall (front wall) on the front side of the housing part 100 configured using the box body. The first opening 100P1 is provided in the front surface part 100F. That is, the front surface part 100F has the first opening 100P1.

The front surface part 100F includes the main-body-side front surface part 101F and the lid-side front surface part 102F. The main-body-side front surface part 101F is a front wall of the main body 101. The lid-side front surface part 102F is a front wall of the lid 102. Note that the front surface part 100F includes a part where the main-body-side front surface part 101F and the lid-side front surface part 102F overlap each other when the lid 102 is put on the main body 101. The main-body-side cutout part 101c recessed rightward is provided at the left end edge of the body-side front surface part 101F. The lid-side cutout part 102c recessed leftward is provided at the right end edge of the lid-side front surface part 102F. The first opening 100P1 is formed of the main-body-side cutout part 101c and the lid-side cutout part 102c. That is, when the lid 102 is put on the main body 101, the opening region of the main-body-side cutout part 101c and the opening region of the lid-side cutout part 102c overlap each other. This overlapping region is the opening of the first opening 100P1.

Since the first opening 100P1 is formed in the front surface part 100F of the housing part 100 in this manner, the upper cables CA1 can be routed through the first opening 100P1. That is, the upper cables CA1 routed through the right side of the operating part 41 can be guided from the front side of the housing part 100 to the inside of the housing part 100 through the first opening 100P1.

Here, a right wall of the operating part 41 is provided on the right side of the housing part 100. Therefore, it is substantially difficult to route the upper cables CA1 guided from the right side of the housing part 100 to the inside of the housing part 100. Furthermore, the left side of the housing part 100 is a space in which a pedal operation by a leg of the operator is performed. When the upper cables CA1 are routed in this space, there is a risk of hindering the pedal operation of the operator. Furthermore, since the auxiliary monitor M2 is arranged above the housing part 100 as described above, it is substantially difficult to route the upper cables CA1. Accordingly, from a viewpoint of facilitating the routing of the upper cables CA1 guided into the housing part 100, the upper cables CA1 are desirably guided inside the housing part 100 from the front side with respect to the housing part 100. In this respect, the configuration in which the first opening 100P1 is provided in the front surface part 100F of the housing part 100 and the upper cables CA1 are guided into the housing part 100 through the first opening 100P1 is very effective.

### 7B. Regarding Details of Arrangement of Plurality of Monitors in Operating Part

FIG. 9B is an enlarged plan view illustrating the operating part 41. FIG. 10B is a left side view of the operating part 41. As illustrated in FIG. 9B, in the present embodiment, the main monitor M1 that is the first monitor and the auxiliary monitor M2 that is the second monitor are arranged in front of the grip part 410 of the right operation lever 41bR and on the right side of the grip part 410. That is, the main monitor M1 and the auxiliary monitor M2 are arranged on the front side and on the second side of the grip part 410 of the operation lever 41b on the second side in the left-right direction among the pair of operation levers 41b. Here, the grip part 410 refers to a part of the operation lever 41b that is gripped during an operation by the operator seated on the driver's seat 41a. Furthermore, the grip part 410 is provided above the operation lever 41b, and the main monitor M1 and the auxiliary monitor M2 are arranged to be shifted in the upper-lower direction as illustrated in FIG. 10B in the present embodiment. More specifically, the auxiliary monitor M2 is arranged above the main monitor M1. In the arrangement of the main monitor M1 and the auxiliary monitor M2 illustrated in FIG. 9B, the operator can operate the main monitor M1 and the auxiliary monitor M2 such that a right arm (the arm on the second side in the left-right direction) of the operator seated on the driver's seat 41a passes through the right side (the second side) of the grip part 410 of the right operation lever 41bR (the operation lever 41b on the second side). Accordingly, when the operator operates the main monitor M1 or the like, it is possible to reduce a possibility that the right arm of the operator accidentally comes into contact with the right operation lever 41bR. Furthermore, a line-of-sight direction when the operator seated on the driver's seat 41a views the main monitor M1 and the auxiliary monitor M2 can be shifted rightward from a line-of-sight direction passing through the grip part 410 of the right operation lever 41bR. Accordingly, the visibility of the main monitor M1 and the auxiliary monitor M2 is not obstructed by the grip part 410 of the right operation lever 41bR. Moreover, the main monitor M1 and the auxiliary monitor M2 are arranged to be shifted in the upper-lower direction as illustrated in FIG. 10B. Therefore, the visibility when the operator sitting on the driver's seat 41a views one monitor (for example, the auxiliary monitor M2) is not obstructed by the presence of the other monitor (for example, the main monitor M1). That is, even when a plurality of monitors (the main monitor M1 and the auxiliary monitor M2) are installed in the operating part 41, it is possible to reduce a possibility that the operator erroneously comes into contact with the right operation lever 41bR at the time of operating the plurality of monitors while ensuring the visibility for each of the plurality of monitors. In the present embodiment, the main monitor M1 and the auxiliary monitor M2 are arranged in an overlapping manner in plan view as illustrated in FIG. 9B. Specifically, the auxiliary monitor M2 is arranged above the main monitor M1 and overlaps a part of the main monitor M1 in plan view. Note that the auxiliary monitor M2 may be arranged so as to overlap the entire main monitor M1 in plan view. In other words, in plan view, the auxiliary monitor M2 may be formed in the same shape as the main monitor M1 or in a shape larger than the main monitor M1, and may be arranged directly above the main monitor M1. In a case where a plurality of monitors are arranged in the operating part 41, it is desirable to efficiently arrange the plurality of monitors in a limited space of the operating part 41. In order to implement such an arrangement, the configuration in which the main monitor M1 and the auxiliary monitor M2 are arranged in an overlapping manner in plan view is effective as in the present embodiment. Furthermore, in the present embodiment, the auxiliary monitor M2 (second monitor) is arranged so as to protrude in the left-right direction with respect to the main monitor M1 (first monitor) as illustrated in FIG. 9B. In the present embodiment, the auxiliary monitor M2 is arranged to protrude to the left side with respect to the main monitor M1. That is, the auxiliary monitor M2 (second monitor) is arranged so as to protrude to the first side in the left-right direction with respect to the main monitor M1 (first monitor). Note that the auxiliary monitor M2 may be arranged to protrude to the right side with respect to the main monitor M1. Furthermore, the auxiliary monitor M2 may be arranged to protrude to both the left side and the right side with respect to the main monitor M1. In a case where more importance is placed on ensuring the visibility of the auxiliary monitor M2 than the main monitor M1, it is desirable to ensure a display region of the auxiliary monitor M2 to be larger than a display region of the main monitor M1 in the left-right direction. From this viewpoint, the auxiliary monitor M2 is desirably arranged so as to protrude in the left-right direction with respect to the main monitor M1. In particular, from a viewpoint of effectively using a free space on the left side of the auxiliary monitor M2 (the space in the left-right direction between the grip part 410 of the right operation lever 41bR and the main monitor M1), the auxiliary monitor M2 is desirably arranged to protrude to the left side with respect to the main monitor M1. The auxiliary monitor M2 is a monitor used when the blade machine control is performed, and is installed as an option in many cases with respect to the existing main monitor M1. From a viewpoint of facilitating a design for retrofitting the auxiliary monitor M2, the auxiliary monitor M2 is desirably arranged above the main monitor M1. Furthermore, the main monitor M1 is arranged to be shifted to the rear side (of the hydraulic excavator 1) with respect to the auxiliary monitor M2 in the present embodiment as illustrated in FIG. 10B. For example, the main monitor M1 may be arranged to be shifted to the front side (of the hydraulic excavator 1) with respect to the auxiliary monitor M2. However, in this arrangement, an upper part of the main monitor M1 is hidden by the auxiliary monitor M2 as viewed from the operator seated on the driver's seat 41a, and there may be a possibility that the visibility of the main monitor M1 is impaired. Therefore, from a viewpoint of satisfactorily ensuring the visibility of both the main monitor M1 and the auxiliary monitor M2, the main monitor M1 is desirably arranged to be shifted to the rear side with respect to the auxiliary monitor M2 as in the present embodiment. In other words, the main monitor M1 is desirably arranged at a position shifted to the rear side immediately below the auxiliary monitor M2. As illustrated in FIGS. 8 to 10B, the operating part 41 includes a console 300. The console 300 is arranged on the right side (the second side in the left-right direction) of the driver's seat 41a. More specifically, the console 300 is arranged between the driver's seat 41a and the cover member 44C, and constitutes the right wall of the operating part 41. The console 300 is provided with various buttons 300B (see FIG. 9B). Note that the console 300 may be provided with a dial, a lamp, a cup holder, and the like. The console 300 has a console body 301 and a front part 302. The console body 301 is arranged on the right side of the driver's seat 41a and extends in the front-rear direction. The front part 302 is arranged on the front side of the console body 301 and is provided integrally with the console body 301. As a result, the console 300 is arranged so as to project forward from a side (particularly the right side) of the driver's seat 41a. As illustrated in FIG. 10B, the front part 302 is arranged to be inclined obliquely upward with respect to the console body 301. That is, the console 300 extends obliquely upward as proceeding forward from the console body 301. The main monitor M1 described above is arranged in the front part 302 of the console 300. More specifically, the main monitor M1 is arranged on an upper surface 302S of the front part 302. The upper surface 302S is formed on the front part 302 so as to face the left side (driver's seat 41a side) in plan view. Therefore, when the main monitor M1 is arranged on the upper surface 302S, the main monitor M1 similarly faces the driver's seat 41a side. Accordingly, the operator seated on the driver's seat 41a can easily visually recognize the main monitor M1. On the other hand, the auxiliary monitor M2 is arranged above the housing part 100 via the support structure part 200 as illustrated in FIGS. 8 and 10B. As illustrated in FIG. 8, the support structure part 200 includes the support stay 201, the support stand 202, and the mounting part 203. The support stay 201 is fixed to the upper part of the housing part 100 by welding or the like. The support stay 201 is formed by bending a flat plate, and is arranged so as to protrude upward from an upper surface of the housing part 100. The support stay 201 supports the support stand 202. A lower end of the support stand 202 is formed in a flange shape, and is fixed to the support stay 201 with a bolt or the like. The support stand 202 extends upward and supports the mounting part 203 at the upper part. The mounting part 203 supports a back surface of the auxiliary monitor M2. The mounting part 203 is configured to be able to adjust a posture (for example, a height position in the upper-lower direction, a rotation angle in the upper-lower direction and the left-right direction, and the like) of the auxiliary monitor M2. As illustrated in FIG. 10B, the housing part 100 is arranged in a space below the console 300 in the operating part 41. More specifically, the housing part 100 is arranged in front of the driver's seat 41a and is arranged on the lower front side of the console 300. Furthermore, the housing part 100 is arranged so as to project forward from the front part 302 of the console 300. The support structure part 200 supported by the upper part of the housing part 100 is located in front of the front part 302 of the console 300. The auxiliary monitor M2 is supported by the support structure part 200 erected in front of the console 300. Even when the auxiliary monitor M2 is additionally (optionally) arranged in the hydraulic excavator 1 in which the main monitor M1 is arranged in the front part 302 of the console 300, the support structure part 200 is erected in front of the console 300, so that the auxiliary monitor M2 can be arranged without interfering with the main monitor M1 arranged in the console 300 (particularly, the front part 302). From a viewpoint of easily implementing such an arrangement of the auxiliary monitor M2, the configuration in which the support structure part 200 is erected in front of the console 300 and the auxiliary monitor M2 is supported by the support structure part 200 as in the present embodiment is desirable. Furthermore, as illustrated in FIG. 10B, the auxiliary monitor M2 that is the second monitor is arranged above the front part 302 of the console 300. Thus, the arrangement in which the auxiliary monitor M2 overlaps the main monitor M1 arranged in the front part 302 in plan view as illustrated in FIG. 9B is easily implemented. As in the present embodiment, in the configuration in which the hydraulic excavator 1 includes the control unit 61 (see FIG. 2) serving as the controller for the blade machine control, the housing part 100 is arranged on the lower front side of the console 300 as described above. Then, the control unit 61 is housed in the housing part 100. Accordingly, if the configuration in which the support structure part 200 is erected above the housing part 100 and the auxiliary monitor M2 is supported by the support structure part 200 is adopted, the housing part 100 can be used as a support base SU (see FIG. 10B) to stably support the support structure part 200 and the auxiliary monitor M2. In this respect, the operating part 41 desirably has the support base SU arranged on the lower front side of the console 300, and the support structure part 200 is supported by the support base SU. In particular, from a viewpoint that the housing part 100 can be effectively used as the support base SU, the support base SU is preferably the housing part 100 that houses the control unit 61. Furthermore, since the housing part 100 is used as the support base SU, it is possible to intensively (efficiently) arrange components and devices for the blade machine control including the auxiliary monitor M2 on the front side of the operating part 41. Also in this respect, the support structure part 200 that supports the auxiliary monitor M2 is desirably supported by the housing part 100 (support base SU). In the configuration in which the second monitor (auxiliary monitor M2) is connected to the control unit 61 via the monitor cable CA-m(See FIGS. 2 and 7) as in the present embodiment, the position information of the blade 51 can be output from the control unit 61 to the auxiliary monitor M2 and displayed on the auxiliary monitor M2. Accordingly, in the configuration in which the auxiliary monitor M2 is installed to perform the blade machine control, effects of the present embodiment described above can be effectively obtained.

### 8. Regarding Second Opening of Housing Part

FIG. 10A is a perspective view illustrating the housing part 100 as viewed from the right rear lower side. The housing part 100 further includes the bottom surface part 103. The bottom surface part 103 is formed of, for example, a plate-like member made of metal, and is arranged at the bottom of the main body 101. The bottom surface part 103 is fixed to the main body 101 by welding or the like.

The bottom surface part 103 has the second opening 100P2. The second opening 100P2 is formed on the rear side of the bottom surface part 103, but the formation position thereof is not particularly limited. Among the cables CA described above, the second detection signal transmission cable CA-s2 and the second authentication cable CA-c2 are routed through the second opening 100P2 and connected to the control unit 61 (see FIG. 9A) inside the housing part 100. That is, the second detection signal transmission cable CA-s2 and the second authentication cable CA-c2 are guided from below to the inside of the housing part 100 through the second opening 100P2. Accordingly, among the cables CA, particularly the second detection signal transmission cable CA-s2 and the second authentication cable CA-c2 are also referred to as lower cables CA2. In this case, it can be said that the cables CA include the lower cables CA2 routed through the second opening 100P2.

The lower cables CA2 are guided from the slip ring SR (see FIG. 2) to the control unit 61 in the housing part 100. Therefore, the lower cables CA2 are routed below the housing part 100 outside the housing part 100. Here, for example, in a case where the second opening 100P2 is not provided in the housing part 100, it is necessary to guide the lower cables CA2 from the first opening 100P1 to the inside of the housing part 100, and it is necessary to arrange the lower cables CA2 in front of the housing part 100. When the second opening 100P2 is provided in the bottom surface part 103 of the housing part 100 and the lower cables CA2 are guided into the housing part 100 through the second opening 100P2 as in the present embodiment, it is not necessary to route the lower cables CA2 in front of the housing part 100. Accordingly, the configuration in which the second opening 100P2 is provided in the housing part 100 is very effective from a viewpoint of eliminating unnecessary routing of the lower cables CA2.

As described above, the lower cables CA2 include the second detection signal transmission cable CA-s2. The second detection signal transmission cable CA-s2 is a sensor cable that transmits a detection signal (posture information of the blade 51) output from the posture detection device 514 (see FIG. 2 and the like) to the control unit 61. In terms of eliminating unnecessary routing of the sensor cable (the second detection signal transmission cable CA-s2), the lower cables CA2 desirably include the sensor cable described above.

Furthermore, the lower cables CA2 include the second authentication cable CA-c2. The second authentication cable CA-c2 is an authentication signal transmission cable. That is, the second authentication cable CA-c2 is a cable for transmitting and receiving an authentication signal between the target prism 512 and the control unit 61. From a viewpoint of eliminating unnecessary routing of the authentication signal transmission cable (the second authentication cable CA-c2), the lower cables CA2 desirably include the above-described authentication signal transmission cable.

Note that the position information transmission cable CA-p is routed through the second opening 100P2 and connected to the control unit 61 inside the housing part 100 as described above. Accordingly, the lower cables CA2 further include the position information transmission cable CA-p. Note that the position information transmission cable CA-p may be routed through the first opening 100P1 and connected to the control unit 61 inside the housing part 100. In this case, it can be said that the upper cables CA1 may include the position information transmission cable CA-p.

### 9. Supplement

Although the hydraulic excavator 1 includes an engine 40 (see FIG. 1) as a prime mover, the prime mover may be an electric motor.

The hydraulic excavator 1 may employ a configuration where a hydraulic device such as a hydraulic actuator (for example, a hydraulic motor and a hydraulic cylinder) and an actuator driven by electric power are used in combination. Examples of the actuator driven by electric power include an electric traveling motor, an electric cylinder, and an electric turning motor.

Although the hydraulic excavator 1 has been described as an example of the working machine in the present embodiment, the working machine is not limited to the hydraulic excavator 1, and may be a construction machine such as a mobile crane. Furthermore, the working machine may be configured such that the upper body does not turn with respect to the lower body.

### 10. Supplementary Note

The working machine (hydraulic excavator 1) described in the present embodiment can be expressed as in the following supplementary notes.

A working machine according to Supplementary Note (1) includes:
a posture detection device attached to a blade of a soil discharging device provided in front of a machine body;
a reception device configured to receive position information of the blade from the outside; and
a controller configured to communicate with the posture detection device and the reception device, wherein
the controller is arranged in front of a driver's seat in an operating part provided in the machine body.

A working machine according to Supplementary Note (2) is the working machine according to Supplementary Note (1), wherein
the operating part includes an entry and exit part on a first side in a left-right direction, and
the controller is arranged on a second side in the left-right direction in the operating part.

A working machine according to Supplementary Note (3) is the working machine according to Supplementary Note (2), further including
a housing part arranged on the second side in the operating part and configured to house the controller, wherein
the housing part further houses a cable extending from the outside to the inside of the housing part above the controller.

A working machine according to Supplementary Note (4) is the working machine according to Supplementary Note (3), wherein
the cable is housed in the housing part in a wound state.

A working machine according to Supplementary Note (5) is the working machine according to Supplementary Note (3) or (4), wherein
the cable includes an upper cable routed through the second side of the operating part.

A working machine according to Supplementary Note (6) is the working machine according to Supplementary Note (5), wherein
the housing part has a front surface part,
the front surface part has a first opening, and
the upper cable is routed through the first opening.

A working machine according to Supplementary Note (7) is the working machine according to Supplementary Note (5) or (6), further including:
a communication device arranged on the second side of the driver's seat; and
a communication gateway communicably connected to the communication device, wherein
the upper cable includes a communication cable connecting the controller and the communication gateway.

A working machine according to Supplementary Note (8) is the working machine according to Supplementary Note (7), wherein
the upper cable includes a data transmission cable connecting the communication device and the communication gateway.

A working machine according to Supplementary Note (9) is the working machine according to any one of Supplementary Notes (3) to (8), further including
a monitor configured to display information output from the controller, wherein
the monitor is supported by the housing part.

A working machine according to Supplementary Note (10) is the working machine according to Supplementary Note (9), wherein
the cable includes a monitor cable connecting the controller and the monitor.

A working machine according to Supplementary Note (11) is the working machine according to any one of Supplementary Notes (3) to (10), wherein
the housing part has a bottom surface part,
the bottom surface part has a second opening, and
the cable includes a lower cable routed through the second opening.

A working machine according to Supplementary Note (12) is the working machine according to Supplementary Note (11), wherein
the lower cable includes a sensor cable that transmits a detection signal output from the posture detection device to the controller.

A working machine according to Supplementary Note (13) is the working machine according to Supplementary Note (11) or (12), wherein
the lower cable includes an authentication cable for transmitting and receiving an authentication signal between a target prism and the controller.

A working machine according to Supplementary Note (14) includes:
an operating part including a driver's seat and configured to allow boarding from a first side in a left-right direction;
a pair of operation levers installed on both left and right sides of the driver's seat; and
a first monitor and a second monitor installed in the operating part, wherein
the first monitor and the second monitor are arranged on a front side and a second side with respect to a grip part of the operation lever on the second side in the left-right direction out of the pair of operation levers, and are arranged to be shifted in an upper-lower direction.

A working machine according to Supplementary Note (15) is the working machine according to Supplementary Note (14), wherein
the first monitor and the second monitor are arranged in an overlapping manner in plan view.

A working machine according to Supplementary Note (16) is the working machine according to Supplementary Note (15), wherein
the second monitor is arranged to protrude in the left-right direction with respect to the first monitor.

A working machine according to Supplementary Note (17) is the working machine according to Supplementary Note (16), wherein
the second monitor is arranged to protrude to the first side in the left-right direction with respect to the first monitor.

A working machine according to Supplementary Note (18) is the working machine according to any one of Supplementary Notes (14) to (17), wherein
the second monitor is arranged above the first monitor.

A working machine according to Supplementary Note (19) is the working machine according to Supplementary Note (18), wherein
the first monitor is arranged to be shifted to a rear side with respect to the second monitor.

A working machine according to Supplementary Note (20) is the working machine according to Supplementary Note (18) or (19), wherein
the operating part includes a console arranged on the second side of the driver's seat,
the console is arranged to project forward from a side of the driver's seat,
the first monitor is arranged in a front part of the console, and
the second monitor is supported by a support structure part erected in front of the console.

A working machine according to Supplementary Note (21) is the working machine according to Supplementary Note (20), wherein
the operating part includes a support base arranged on a lower front side of the console, and
the support structure part is supported by the support base.

A working machine according to Supplementary Note (22) is the working machine according to Supplementary Note (21), further including
a controller to which positional information of a blade of a soil discharging device provided in front of a machine body is input, wherein
the support base is a housing part that houses the controller.

A working machine according to Supplementary Note (23) is the working machine according to Supplementary Note (22), wherein
the second monitor is connected to the controller via a monitor cable.

A working machine according to Supplementary Note (24) is the working machine according to any one of Supplementary Notes (20) to (23), wherein
the second monitor is arranged above the front part of the console.

Although the embodiment of the present invention has been described above, the scope of the present invention is not limited thereto, and may be expanded or modified without departing from the gist of the invention.

### INDUSTRIAL APPLICABILITY

The present invention is applicable to working machines such as construction machines.

### LIST OF REFERENCE SIGNS

1 Hydraulic excavator (working machine)
1a Machine body
2 Lower traveling body (machine body)
4 Upper turning body (machine body)
5 Soil discharging device
41 Operating part
41a Driver's seat
41b Operation lever
41bL Left operation lever (operation lever on first side in left-right direction)
41bR Right operation lever (operation lever on second side in left-right direction)
41c Entry and exit part
51 Blade
61 Control unit (controller)
62 Reception device
63 Communication device
64 Communication gateway
100 Housing part
100F Front surface part
100P1 First opening
100P2 Second opening
103 Bottom surface part
200 Support structure part
300 Console
302 Front part
410 Grip part
512 Target prism
514 Posture detection device
CA Cable
CA1 Upper cable
CA2 Lower cable
CA-c Authentication cable
CA-c1 First authentication cable
CA-c2 Second authentication cable (authentication signal transmission cable)
CA-d Data transmission cable
CA-g Communication cable
CA-m Monitor cable
CA-s Detection signal transmission cable
CA-s1 First detection signal transmission cable
CA-s2 Second detection signal transmission cable (sensor cable)
M1 Main monitor (first monitor)
M2 Auxiliary monitor (second monitor)
SU Support base

1. A working machine comprising:
a posture detection device attached to a blade of a soil discharging device provided in front of a machine body;
a reception device configured to receive position information of the blade from outside; and
a controller configured to communicate with the posture detection device and the reception device, wherein
the controller is arranged in front of a driver's seat in an operating part provided in the machine body.

2. The working machine according to claim 1, wherein
the operating part includes an entry and exit part on a first side in a left-right direction, and
the controller is arranged on a second side in the left-right direction in the operating part.

3. The working machine according to claim 2, further comprising
a housing part arranged on the second side in the operating part and configured to house the controller, wherein
the housing part further houses a cable extending from outside to inside of the housing part above the controller.

4. The working machine according to claim 3, wherein the cable is housed in the housing part in a wound state.

5. The working machine according to claim 3, wherein the cable includes an upper cable routed through the second side of the operating part.

6. The working machine according to claim 5, wherein
the housing part has a front surface part,
the front surface part has a first opening, and
the upper cable is routed through the first opening.

7. The working machine according to claim 5, further comprising:
a communication device arranged on the second side of the driver's seat; and
a communication gateway communicably connected to the communication device, wherein
the upper cable includes a communication cable connecting the controller and the communication gateway.

8. The working machine according to claim 7, wherein
the upper cable includes a data transmission cable connecting the communication device and the communication gateway.

9. The working machine according to claim 3, further comprising
a monitor configured to display information output from the controller, wherein
the monitor is supported by the housing part.

10. The working machine according to claim 9, wherein the cable includes a monitor cable connecting the controller and the monitor.

11. The working machine according to claim 3, wherein
the housing part includes a bottom surface part,
the bottom surface part has a second opening, and
the cable includes a lower cable routed through the second opening.

12. The working machine according to claim 11, wherein
the lower cable includes a sensor cable that transmits a detection signal output from the posture detection device to the controller.

13. The working machine according to claim 11, wherein
the lower cable includes an authentication signal transmission cable for transmitting and receiving an authentication signal between a target prism and the controller.

14. A working machine comprising:
an operating part including a driver's seat and configured to allow boarding from a first side in a left-right direction;
a pair of operation levers installed on both left and right sides of the driver's seat; and
a first monitor and a second monitor installed in the operating part, wherein
the first monitor and the second monitor are arranged on a front side and a second side with respect to a grip part of the operation lever on the second side in the left-right direction out of the pair of operation levers, and are arranged to be shifted in an upper-lower direction.

15. The working machine according to claim 14, wherein
the second monitor is arranged above the first monitor, and
the first monitor is arranged to be shifted to a rear side with respect to the second monitor.

16. The working machine according to claim 14, wherein
the operating part includes a console arranged on the second side of the driver's seat,
the console is arranged to project forward from a side of the driver's seat,
the first monitor is arranged in a front part of the console,
the second monitor is supported by a support structure part erected in front of the console, and
the second monitor is arranged above the first monitor.

17. The working machine according to claim 16, wherein
the operating part includes a support base arranged on a lower front side of the console, and
the support structure part is supported by the support base.

18. The working machine according to claim 17, further comprising
a controller to which positional information of a blade of a soil discharging device provided in front of a machine body is input, wherein
the support base is a housing part that houses the controller.

19. The working machine according to claim 18, wherein
the second monitor is connected to the controller via a monitor cable.

20. The working machine according to claim 16, wherein
the second monitor is arranged above the front part of the console.
